(19) United States
(12) Patent Application Publication
(10) Pub. No.: US 2020/0162987 A1
(43) Pub. Date: May 21, 2020

(54) COMMUNICATION DEVICE, COMMUNICATION SYSTEM, AND BAND CONTROL METHOD

(71) Applicant: PANASONIC CORPORATION, Osaka (JP)

(72) Inventors: Noriyuki SHIMIZU, Kanagawa (JP); Hiroaki ASANO, Kanagawa (JP); Hideki SHINGU, Tokyo (JP); Takeshi MIYAGOSHI, Kanagawa (JP)

(73) Assignee: PANASONIC CORPORATION, Osaka (JP)

(21) Appl. No.: 16/623,678

(22) PCT Filed: Mar. 12, 2018
(86) PCT No.: PCT/JP2018/009374

§ 371 Date: Dec. 17, 2019

(30) Foreign Application Priority Data
Jun. 19, 2017 (JP) 2017-119448

(51) Int. Cl. H04W 36/24; H04W 36/14; H04W 28/20; H04W 36/04; H04W 36/30; H04W 28/22; H04W 36/32

(52) U.S. Cl. CPC H04W 36/245; H04W 36/14; H04W 28/20; H04W 36/32; H04W 36/30; H04W 28/22; H04W 36/04

(57) ABSTRACT

In order to properly control a communication bandwidth used for communication without increasing load of a network, a communication device includes a controller configured to control a communication bandwidth used for transmitting application data by using a congestion control algorithm, wherein, when a connection destination is changed, the controller acquires an initial value of the communication bandwidth appropriate for the connection destination based on an initial value table, and starts control of the communication bandwidth by using the initial value.

### TECHNICAL FIELD

The present invention relates to a communication device for communicating application data via a base station used as a connection destination, a communication system in which a communication device communicates application data via a base station used as a connection destination, and a band control method for controlling a communication bandwidth used by a communication device to communicate application data via a base station used as a connection destination.

### BACKGROUND ART

5G systems (Fifth generation mobile communication systems) have been considered for introduction into general use in wireless communications. In 5G systems, what is called a heterogeneous network is constructed, in which communication areas supporting various different RATs (Radio Access Technologies) overlap each other, where different RATs provide different communication performances such as communication area and communication speed. In such a heterogeneous network, when a user terminal moves, its connection destination can change, resulting in changes in communication performance.

For a fair and efficient use of available communication bandwidth, a communication bandwidth is controlled by using a congestion control algorithm, which, however, has a problem in followability to the expansion of a communication bandwidth. As a result, a large-capacity communication environment provided by a 5G system cannot be fully utilized. In particular, in cases of a base station using RATs utilizing EHF bands, since its communication area is rather small, there is a problem that a terminal device often passes through the communication area without fully utilizing their large-capacity communication environments.

Moreover, a technology using a congestion control algorithm grasps an estimated communication bandwidth available to a user terminal based on a packet loss rate and a delay time (RTT) acquired by using transferred monitoring packets for monitoring communication status. Such a technology inconveniently increases load of a network because of the transfer of monitoring packets.

Thus, there is a need for technologies which enable a user terminal to quickly grasp an available communication bandwidth without increasing the load of a network. Known technologies which can satisfy this need include a method for determining an available communication bandwidth, the method involving accumulating information on communication status as historical information in a terminal device, retrieving a piece of historical information on communication status close to a current communication status of the terminal device, and determining an estimated available communication bandwidth based on the retrieved piece of historical information. (See Patent Document 1)

### PRIOR ART DOCUMENT(S)

### Patent Document(s)

Patent Document 1: JP2012-244492A

### SUMMARY OF THE INVENTION

### Task to be Accomplished by the Invention

However, the above-described prior art method involves a problem of improper control of an available communication bandwidth in some cases, which problem is caused because the determination of available communication bandwidth is based only on historical information on communication status. For example, s since communication status can be changed because of an obstacle or other factors, a terminal device at a certain location can communicate with different connection destination. Under this condition, incorrect control of the available communication bandwidth can occur as the determination of available communication bandwidth is based only on historical information on communication status.

The present invention has been made in view of the problem of the prior art, and a primary object of the present invention is to provide a communication device, a communication system, and a band control method for controlling a communication bandwidth, which enable proper control of the communication bandwidth without increasing load of a network.

### Means to Accomplish the Task

An aspect of the present invention provides a communication device for communicating application data via a base station used as a connection destination, the communication device comprising: a wireless communication device configured to wirelessly communicate with the base station used as the connection destination; a storage configured to store initial setting information concerning an initial value of a communication bandwidth appropriate for the connection destination; and a controller configured to control the communication bandwidth used for transferring the application data by using a congestion control algorithm, and configured such that, when the connection destination is changed, the controller acquires the initial value of the communication bandwidth appropriate for the connection destination based on the initial setting information, and starts controlling the communication bandwidth by using the initial value.

Another aspect of the present invention provides a communication system in which a communication device communicates application data via a base station used as a connection destination, wherein the communication device comprises: a wireless communication device configured to wirelessly communicate with the base station used as the connection destination; a storage configured to store initial setting information concerning an initial value of the communication bandwidth appropriate for the connection destination; and a controller configured to control a communication bandwidth used for transferring the application data by using a congestion control algorithm, and configured such that, when the connection destination is changed, the controller acquires the initial value of the communication bandwidth appropriate for the connection destination based on the initial setting information, and starts control of the communication bandwidth by using the initial value.

Yet another aspect of the present invention provides a band control method for controlling a communication bandwidth used by a communication device to communicate application data via a base station used as a connection destination, the method comprising: the communication device controlling a communication bandwidth used for transferring the application data by using a congestion control algorithm, and when the connection destination is changed, the communication device acquiring an initial value of the communication bandwidth appropriate for the connection destination based on initial setting information, and starting control of the communication bandwidth by using the initial value.

### Effect of the Invention

According to the present invention, a corresponding initial value for each connection destination is used to start control of a communication bandwidth. This configuration enables proper control of the communication bandwidth without increasing load of a network.

### BRIEF DESCRIPTION OF THE DRAWINGS

FIG. 1 is a diagram showing a general configuration of a communication system according to a first embodiment of the present invention;

FIG. 2 is a block diagram showing a general configuration of a macro cell base station 3 according to the first embodiment of the present invention;

FIG. 3 is a block diagram showing a general configuration of a user terminal 1 according to the first embodiment of the present invention;

FIG. 4 is an explanatory view showing an example of an initial value table according to the first embodiment of the present invention;

FIG. 5 is a flowchart showing an operation procedure of a bandwidth controller 42 in the user terminal 1 according to the first embodiment of the present invention;

FIG. 6 is a sequence diagram showing an operation procedure of the user terminal 1 according to the first embodiment of the present invention;

FIG. 7 is a block diagram showing a general configuration of a user terminal 1 according to a second embodiment of the present invention;

FIG. 8 is an explanatory view showing an example of a communication history database according to the second embodiment of the present invention;

FIG. 9 is an explanatory view showing examples of initial value tables according to the second embodiment of the present invention;

FIG. 10 is a flowchart showing an operation procedure of a communication bandwidth initial value acquisition operation performed by a bandwidth controller 42 in the user terminal 1 according to the second embodiment of the present invention;

FIG. 11 is a sequence diagram showing an operation procedure of the user terminal 1 according to the second embodiment of the present invention;

FIG. 12 is an explanatory view showing an outline of control of bandwidth according to a variation of the second embodiment of the present invention;

FIG. 13 is an explanatory view showing an example of a communication history database according to the variation of the second embodiment of the present invention;

FIG. 14 is a flowchart showing an operation procedure of a communication bandwidth initial value acquisition operation performed by a bandwidth controller 42 in the user terminal according to the variation of the second embodiment of the present invention;

FIG. 15 is a block diagram showing a general configuration of a user terminal 1 according to a third embodiment of the present invention;

FIG. 16 is an explanatory view showing how the bandwidth is controlled according to the third embodiment of the present invention;

FIG. 17 is an explanatory view showing an example of a correction coefficient table according to the third embodiment of the present invention;

FIG. 18 is a flowchart showing an operation procedure of a communication bandwidth initial value acquisition operation performed by a bandwidth controller 42 in the user terminal 1 according to the third embodiment of the present invention;

FIG. 19 is a sequence diagram showing an operation procedure of the user terminal 1 according to the third embodiment of the present invention;

FIG. 20 is a block diagram showing a general configuration of a user terminal 1 according to a fourth embodiment of the present invention;

FIG. 21 is an explanatory view showing how the bandwidth is controlled according to the fourth embodiment of the present invention;

FIG. 22 is an explanatory view showing an example of a correction coefficient table according to the fourth embodiment of the present invention;

FIG. 23 is a flowchart showing an operation procedure of a communication bandwidth initial value acquisition operation performed by a bandwidth controller 42 in the user terminal 1 according to the fourth embodiment of the present invention;

FIG. 24 is a sequence diagram showing an operation procedure of the user terminal 1 according to the fourth embodiment of the present invention;

FIG. 25 is an explanatory view showing an outline of control of bandwidth according to a fifth embodiment of the present invention;

FIG. 26 is a flowchart showing an operation procedure of a bandwidth controller 42 in the user terminal 1 according to the fifth embodiment of the present invention; and

FIG. 27 is a sequence diagram showing an operation procedure of the user terminal 1 according to the fifth embodiment of the present invention.

### DESCRIPTION OF THE PREFERRED EMBODIMENT(S)

A first aspect of the present invention made to achieve the above-described object is a communication device for communicating application data via a base station used as a connection destination, the communication device comprising: a wireless communication device configured to wirelessly communicate with the base station used as the connection destination; a storage configured to store initial setting information concerning an initial value of a communication bandwidth appropriate for the connection destination; and a controller configured to control the communication bandwidth used for transferring the application data by using a congestion control algorithm, and configured such that, when the connection destination is changed, the controller acquires the initial value of the communication bandwidth appropriate for the connection destination based on the initial setting information, and starts controlling the communication bandwidth by using the initial value.

In this configuration, a corresponding initial value for each connection destination is used to start control of a communication bandwidth. This enables proper control of the communication bandwidth without increasing load of a network.

A second aspect of the present invention is the communication device of the first aspect, wherein the storage is configured to accumulate historical information on past communication status, and wherein, when the storage stores historical information on past communication status close to a current communication status of the communication device, the controller acquires, based on the historical information, the initial value of the communication bandwidth, and when the storage does not store historical information on past communication status close to the current communication status of the communication device, the controller acquires, based the initial setting information, the initial value of the communication bandwidth.

In this configuration, since an initial value of the communication bandwidth is acquired based on historical information on past communication status close to a current communication status of the communication device, the communication bandwidth can be more properly controlled.

A third aspect of the present invention is the communication device of the second aspect, wherein the controller acquires the initial value of the communication bandwidth based on the historical information regarding a current location of the communication device.

In this configuration, since an initial value of the communication bandwidth is acquired based on historical information regarding a current location of the communication device, the communication bandwidth can be more properly controlled.

A fourth aspect of the present invention is the communication device of the second aspect, wherein the controller acquires the initial value of the communication bandwidth based on the historical information regarding both a current location and a peripheral location, the peripheral location being is an immediately preceding location of the communication device before the communication device coming to the current location.

In this configuration, since an initial value of the communication bandwidth is acquired based on historical information regarding a current location and a peripheral location of the communication device, the communication bandwidth can be more properly controlled.

A fifth aspect of the present invention is the communication device of the fourth aspect, wherein the controller acquires, from the historical information regarding the current location, a past communication bandwidth distribution at the current location, acquires, from the historical information regarding the peripheral location, a past communication bandwidth distribution at the peripheral locations, determining a deviation of an immediately preceding communication bandwidth at the peripheral location from the past communication bandwidth distribution at the peripheral locations, and applying the determined deviation to the past communication bandwidth distribution at the current location to thereby acquire a current communication bandwidth at the current location, and then set the acquired current communication bandwidth as an initial value of the communication bandwidth.

In this configuration, a proper initial value of the communication bandwidth can be acquired based on historical information regarding a current location and a peripheral location of the communication device.

A sixth aspect of the present invention is the communication device of the first aspect, wherein the controller acquires the initial value of the communication bandwidth based on a type of application presently performing communication.

In this configuration, since an initial value of the communication bandwidth is acquired based on a type of application presently performing communication, the communication bandwidth can be more properly controlled.

A seventh aspect of the present invention is the communication device of the sixth aspect, wherein the storage stores correction coefficient setting information on a correction coefficient appropriate for the type of application presently performing communication; and wherein the controller, which acquires the initial value of the communication bandwidth appropriate for the connection destination based on the initial setting information, also acquires the correction coefficient appropriate for the type of application based on the correction coefficient setting information, and corrects the initial value of the communication bandwidth by multiplying the initial value of the communication bandwidth by the correction coefficient.

In this configuration, a proper initial value of the communication bandwidth can be acquired by taking into consideration both a connection destination and a type of application presently performing communication.

An eighth aspect of the present invention is the communication device of the first aspect, wherein the controller acquires the initial value of the communication bandwidth based on a moving speed of the communication device.

In this configuration, since an initial value of the communication bandwidth is acquired based on a moving speed of the communication device, the communication bandwidth can be more properly controlled.

A ninth aspect of the present invention is the communication device of the eighth aspect, wherein the storage stores correction coefficient setting information on a correction coefficient appropriate for the moving speed of the communication device; and wherein the controller, which acquires the initial value of the communication bandwidth appropriate for the connection destination based on the initial setting information, also acquires the correction coefficient appropriate for the moving speed of the communication device based on the correction coefficient setting information, and corrects the initial value of the communication bandwidth by multiplying the initial value of the communication bandwidth by the correction coefficient.

In this configuration, a proper initial value of the communication bandwidth can be acquired by taking into consideration both a connection destination and a moving speed of the communication device.

A tenth aspect of the present invention is a communication device for communicating application data via a base station used as a connection destination, the communication device comprising: a wireless communication device configured to wirelessly communicate with the base station used as the connection destination; a storage configured to store initial setting information concerning an initial value of the communication bandwidth appropriate for a wireless communication quality level; and a controller configured to control a communication bandwidth used for transferring the application data by using a congestion control algorithm, and configured such that, when a change in the wireless communication quality level exceeds a prescribed threshold value, the controller acquires the initial value of the communication bandwidth appropriate for the changed wireless communication quality level based on the initial setting information, and starts control of the communication bandwidth by using the initial value.

In this configuration, when a communication quality level is rapidly changed because of an obstacle or other factors, an initial value of the communication bandwidth appropriate for the changed communication quality level is used to start control of a communication bandwidth. This enables proper control of the communication bandwidth without increasing load of a network.

An eleventh aspect of the present invention is a communication system in which a communication device communicates application data via a base station used as a connection destination, wherein the communication device comprises: a wireless communication device configured to wirelessly communicate with the base station used as the connection destination; a storage configured to store initial setting information concerning an initial value of the communication bandwidth appropriate for the connection destination; and a controller configured to control a communication bandwidth used for transferring the application data by using a congestion control algorithm, and configured such that, when the connection destination is changed, the controller acquires the initial value of the communication bandwidth appropriate for the connection destination based on the initial setting information, and starts control of the communication bandwidth by using the initial value.

This configuration enables proper control of the communication bandwidth without increasing load of a network in the same manner as the first aspect of the present invention.

A twelfth aspect of the present invention is a band control method for controlling a communication bandwidth used by a communication device to communicate application data via a base station used as a connection destination, the method comprising: the communication device controlling a communication bandwidth used for transferring the application data by using a congestion control algorithm, and when the connection destination is changed, the communication device acquiring an initial value of the communication bandwidth appropriate for the connection destination based on initial setting information, and starting control of the communication bandwidth by using the initial value.

This configuration enables proper control of the communication bandwidth without increasing load of a network in the same manner as the first aspect of the present invention.

Embodiments of the present invention will be described below with reference to the drawings.

### First Embodiment

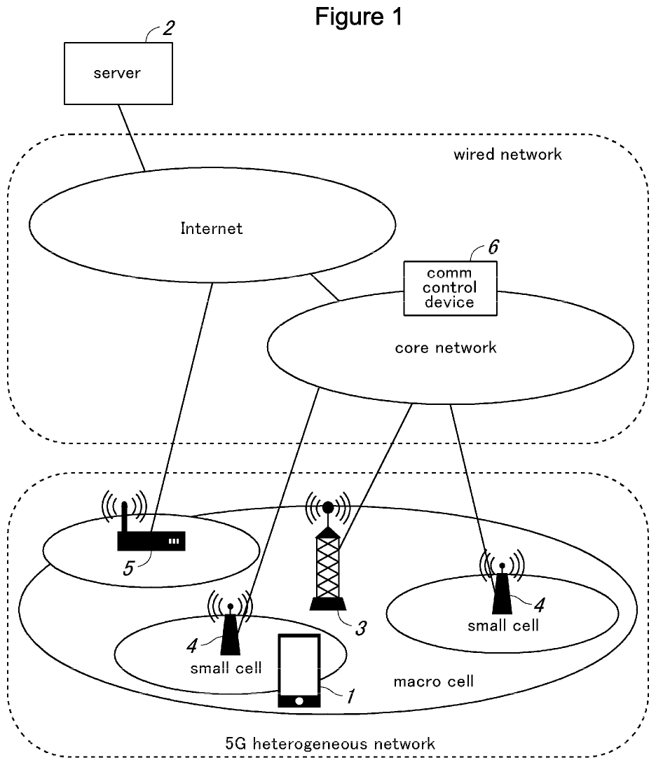

FIG. 1 is a diagram showing a general configuration of a communication system according to a first embodiment of the present invention.

The communication system includes a user terminal 1 (communication device), a server 2 (counterpart device), a macro cell base station 3 (base station device), small cell base stations 4 (base station devices), a wireless LAN access point 5 (base station), and a communication control device 6.

A communication area of the macro cell base station 3 overlaps with those of the small cell base stations 4 and the wireless LAN access point 5, whereby what is called a heterogeneous network is constructed, in which a communication environment supporting multiple RATs (Radio Access Technologies) is provided.

The user terminal 1 may be a smartphone, a tablet terminal, and any other suitable terminal device. The user terminal 1 is capable of being connected to the macro cell base station 3, the small cell base stations 4 and the wireless LAN access point 5, which construct the heterogeneous network. The user terminal 1 communicates with the server 2 via the heterogeneous network, a wired network including the Internet and a core-network.

The server 2 is configured to receive and store video data shot by the user terminal 1. The server 2 also distributes various contents to the user terminal 1.

The macro cell base station 3 performs wireless communication using a UHF band, e.g. wireless communication using LTE (Long Term Evolution) scheme. The macro cell base station 3 is a C-plane cell, which handles control plane (C-Plane) massages for transmitting control signals. In other embodiments, the macro cell base station 3 may be used as a U-Plane cell, which handles user plane (U-Plane) messages for transmitting user data.

The small cell base stations 4 perform wireless communication using a high SHF band or EHF band (millimeter wave band), which can comply with 5G NR (New Radio). The small cell base stations 4 are used as cells handling user plane (U-Plane) messages for transmitting user data.

The wireless LAN access point 5 is configured to perform relatively large capacity wireless communication using a suitable wireless communication scheme such as a WiFi (Registered Trademark) communication system or a WiGig (Registered Trademark) communication system.

The communication control device 6 may be an LTE communication device such as S-GW (Serving Gateway) or P-GW (Packet data network Gateway) for controlling wireless communication using a macro cell base station (LTE), or an NR communication device such as SMF (Session Management Function) device or UPF (User Plane Function) device for controlling wireless communication using a small cell base station (NR).

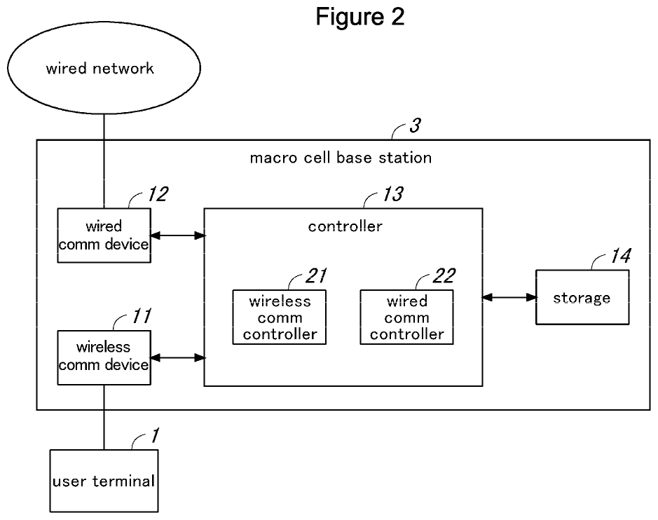

Next, a general configuration of the macro cell base station 3 according to the first embodiment of the present invention will be described. FIG. 2 is a block diagram showing a general configuration of the macro cell base station 3.

The macro cell base station 3 includes a wireless communication device 11, a wired communication device 12, a controller 13, and a storage 14.

The wireless communication device 11 performs wireless communication with the user terminal 1.

The wired communication device 12 performs wired communication with the communication control device 6 such as S-GW, a nearby macro cell base station(s) 3 and/or a nearby small cell base station(s) 4.

The storage 14 stores information on the user terminal 1, information on other nearby macro cell base station(s) 3 and small cell base station(s) 4, and a program(s) executable by a processor which implements the controller 13.

The controller 13 includes a wireless communication controller 21 and a wired communication controller 22. The controller 13 is implemented by the processor, and each part of the controller 13 is implemented by the processor executing a corresponding program stored in the storage 14.

The wireless communication controller 21 is configured to control wireless communication with the user terminal 1 based on wireless communication quality level information transmitted from the user terminal 1, and instruct the user terminal 1 to change its proper connection destination (CD).

The wired communication controller 22 is configured to exchange information on connection destination(s) of the user terminal or some other information through wired communication with the communication control device 6 such as S-GW, the nearby macro cell base station(s) 3 and/or the nearby small cell base station(s) 4.

In FIG. 2, the general configuration of the macro cell base station 3 is shown. However, each small cell base station 4 and the wireless LAN access point 5 have substantially the same general configuration as the macro cell base station.

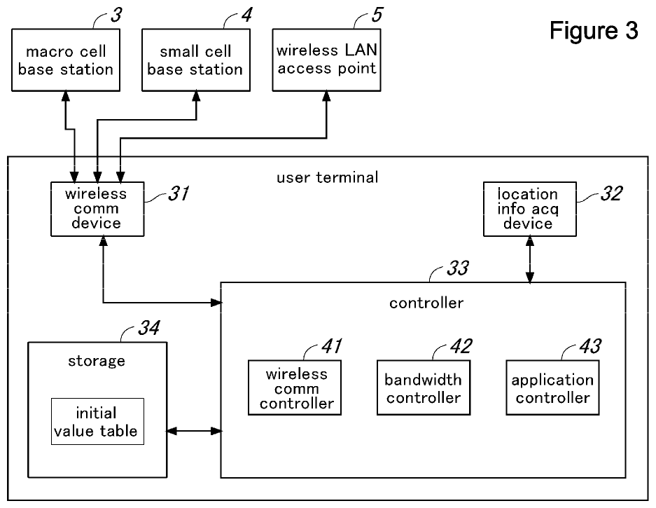

Next, a general configuration of the user terminal 1 according to the first embodiment of the present invention will be described. FIG. 3 is a block diagram showing a general configuration of the user terminal 1.

The user terminal 1 includes a wireless communication device 31, a location information acquisition device 32, a controller 33, and a storage 34.

The wireless communication device 31 performs wireless communication with the macro cell base station 3, the small cell base stations 4, and the wireless LAN access point 5, which construct a 5G heterogeneous network, and performs communication with the server 2 via the 5G heterogeneous network and the wired network.

The location information acquisition device 32 acquires location information on the location of the user terminal itself by using a satellite positioning system such as a GPS (Global Positioning System).

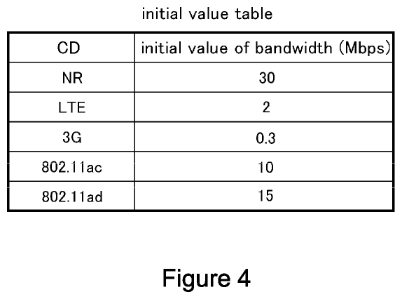

The storage 34 stores information on the user terminal itself, information on base stations, and programs executable by a processor, which implement the controller 33. In the present embodiment, the storage 34 stores an initial value table (see FIG. 4).

The controller 33 includes a wireless communication controller 41, a bandwidth controller 42, and an application controller 43. The controller 33 is implemented by the processor, and each part of the controller 33 is implemented by the processor executing a corresponding program stored in the storage 34.

The wireless communication controller 41 controls wireless communication performed by the wireless communication device 31, and based on wireless communication quality level information, selects a proper connection destination (the macro cell base station 3, small cell base stations 4, or wireless LAN access point 5).

The application controller 43 performs an operation(s) required for each application, and transmits and receives application data to and from the server 2 via the wireless communication device 31.

The bandwidth controller 42 controls, based on the congestion control algorithm, a communication bandwidth (CBW) to be given to the application controller 43. The bandwidth controller 42 performs a bandwidth estimation operation for estimating a current communication bandwidth based on various parameters, and gives an estimated current communication bandwidth to the application controller 43. In the present embodiment, the communication bandwidth is controlled based on connection destination (CD) information acquired by the wireless communication controller 41. Specifically, when the connection destination is changed, the bandwidth controller 42 refers to the initial value table (see FIG. 4) and acquires an initial value of the communication bandwidth appropriate for each connection destination, and using the acquired initial value, starts control of the communication bandwidth.

The parameters used to estimate a current communication bandwidth vary depending on an adopted congestion control algorithm. For example, TFRC (TCP Friendly Rate Control) uses a packet loss rate and a delay time (RTT) as parameters for communication bandwidth estimation.

Types of changes in the connection destination include switch of the connection destination to another, addition of a connection destination, and deletion of the connection destination. The switch of the connection destination to another occurs when, for example, the connection destination is switched from a small cell base station 4 to the wireless LAN access point 5, or conversely, when the connection destination is switched from the wireless LAN access point 5 to a small cell base station 4. The addition of a connection destination occurs when, for example, a small cell base station 4 or the wireless LAN access point 5 is added as a new connection destination other than the macro cell base station 3 with which the user terminal presently performing communication. The deletion of the connection destination occurs when, for example, the user terminal disconnects from the wireless LAN access point 5 or a small cell base station 4 with which the terminal has been performing communication, and then the disconnected wireless LAN access point 5 or small cell base station 4, which has been its connection destination, is deleted.

Next, the initial value table according to the first embodiment of the present invention will be described. FIG. 4 is an explanatory view showing an example of an initial value table.

The bandwidth controller 42 of the user terminal 1 acquires, referring to the initial value table (initial value setting information) stored in the storage 34, a corresponding initial value of the communication bandwidth (average throughput) for each connection destination.

This initial value table includes initial values of the communication bandwidth, each value being appropriate for a corresponding RAT (Radio Access Technology) of a connection destination (CD). In the example of FIG. 4, the table includes respective initial values of the communication bandwidth for RATs of 5G NR (New Radio), LTE (Long Term Evolution), 3G, 802.11ac, and 802.11ad (RATs of 802.11ac and 802.11ad are standards for wireless LANs established by IEEE. The Institute of Electrical and Electronics Engineers).

An initial value of the communication bandwidth for each connection destination is determined based on the system capacity associated with a RAT of each connection destination and the capability of the user terminal 1.

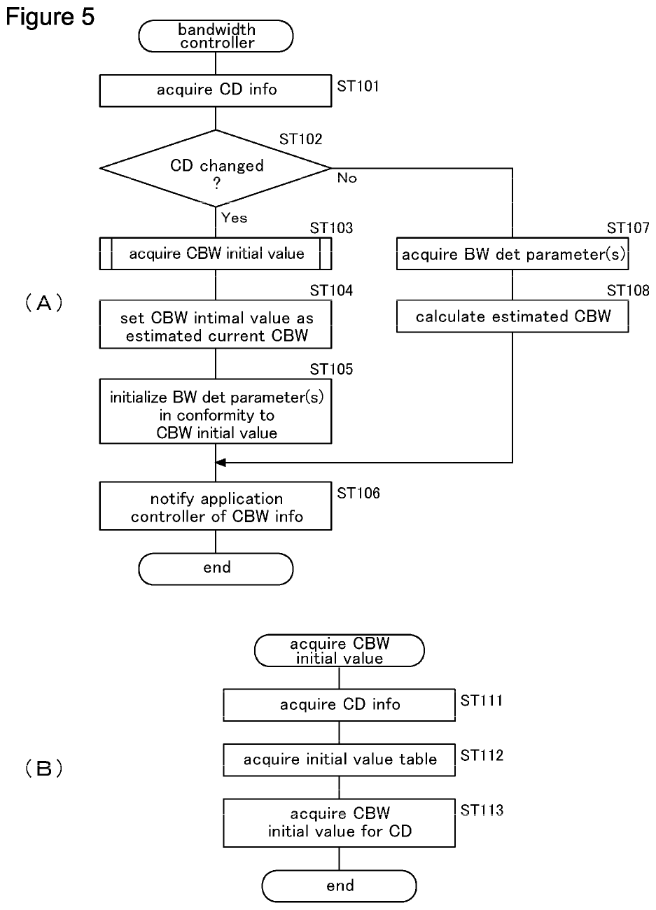

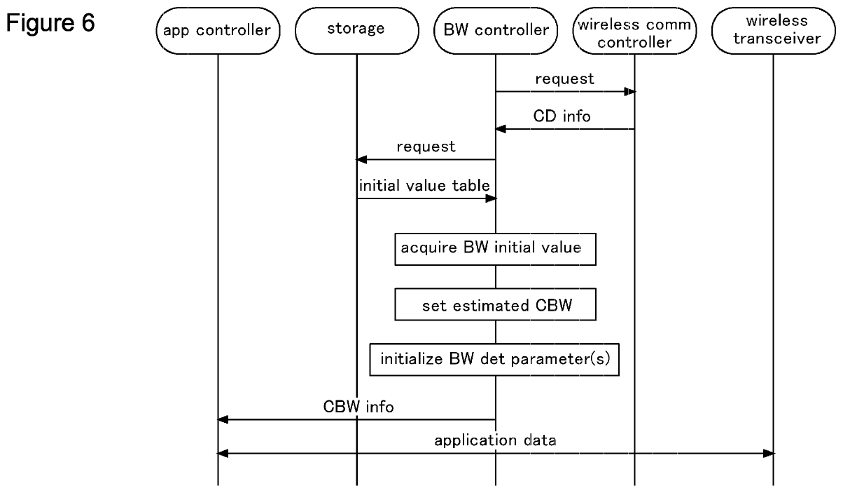

Next, an operation procedure of the user terminal 1 according to the first embodiment of the present invention will be described. FIG. 5 is a flowchart showing an operation procedure of the bandwidth controller 42 in the user terminal 1. FIG. 6 is a sequence diagram showing an operation procedure of the user terminal 1.

First, the bandwidth controller 42 acquires connection destination information (CD information) from the wireless communication controller 41 (ST101). Then, the bandwidth controller 42 determines whether or not a change in the connection destination (CD) occurs based on the connection destination information (ST102). In this connection, a change in the connection destination occurs when the connection destination has already been changed by the wireless communication controller 41, as well as when it is determined that a condition(s) for causing a change in the connection destination is met based on a measurement result of a communication quality level to be given to the macro cell base station 3 as a measurement report (Measurement Report).

When the change in the connection destination occurs (Yes in ST102), the bandwidth controller 42 acquires an initial value of the communication bandwidth (CBW) (ST103). Then, the bandwidth controller sets the acquired communication bandwidth as an estimated current communication bandwidth (control value). Also, the bandwidth controller 42 initializes bandwidth determination parameters (packet loss rate and delay time) so as to be in conformity to the communication bandwidth initial value (ST105). Then, the bandwidth controller 42 starts control of the communication bandwidth (bandwidth estimation) by using the initial value of the communication bandwidth.

In the step of initializing the bandwidth determination parameters (ST105), the bandwidth determination parameters are determined by back calculating from the initial value of the communication bandwidth by using a bandwidth calculation formula for estimating a communication bandwidth from the bandwidth determination parameters. Alternatively, a table representing the relationship between bandwidth determination parameters and initial values of the communication bandwidth is prepared in advance, and the table is used to determine bandwidth determination parameters from the initial value of the communication bandwidth.

Next, the bandwidth controller 42 notifies the application controller 43 of the communication bandwidth information (ST106). Then, the application controller 43 transmits and receives application data to and from the server via the wireless communication device 31 using the communication bandwidth designated by the bandwidth controller 42.

When any change in the connection destination does not occur (No in ST102), the bandwidth controller 42 acquires bandwidth determination parameters for the current communication status (ST107). Moreover, the bandwidth controller 42 calculates an estimated value of the communication bandwidth based on the bandwidth determination parameters (ST108). Then, the process proceeds to ST106.

In the step of acquiring an initial value of the communication bandwidth (ST103), the bandwidth controller 42 first acquires connection destination information from the wireless communication controller 41 (ST111). Also, the bandwidth controller 42 acquires the initial value table from the storage 34 (ST112). Then, the bandwidth controller 42, referring s to the initial value table, acquires an initial value of the communication bandwidth appropriate for the connection destination (ST113).

### Second Embodiment

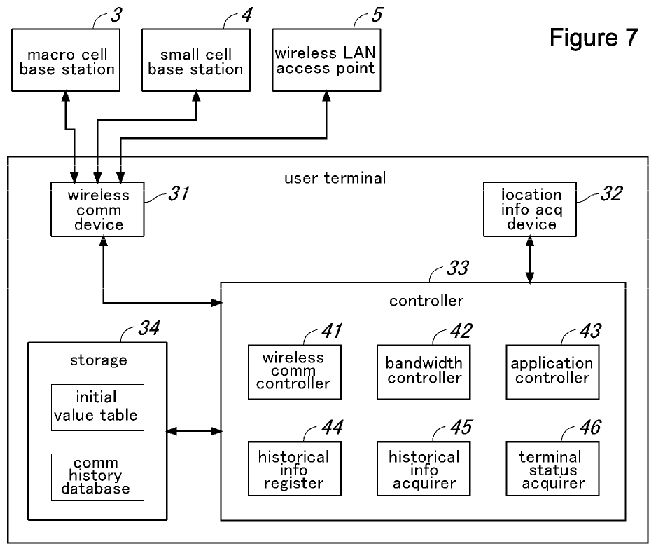

Next, a second embodiment of the present invention will be described. Except for what will be discussed here, this embodiment is the same as the above-described embodiment. FIG. 7 is a block diagram showing a general configuration of a user terminal 1 according to a second embodiment of the present invention.

A communication bandwidth available to the user terminal 1 (available bandwidth) varies depending on the location of the user terminal 1 and the communication status such as day of the week or time of day. In this view, in the present embodiment, the user terminal 1, which is configured to accumulate historical information on past communication status at each location, acquires historical information regarding the current location and on past communication status close to a current communication status (such as day of the week, time of day, connection destination, wireless communication quality level) of the user terminal 1, and then retrieves the past actual value of the communication bandwidth included in the acquired historical information as an initial value of the communication bandwidth.

The user terminal 1 includes a wireless communication device 31, a location information acquisition device 32, a controller 33, and a storage 34 in the same manner as the first embodiment. The wireless communication device 31 has the same configuration as that of the first embodiment.

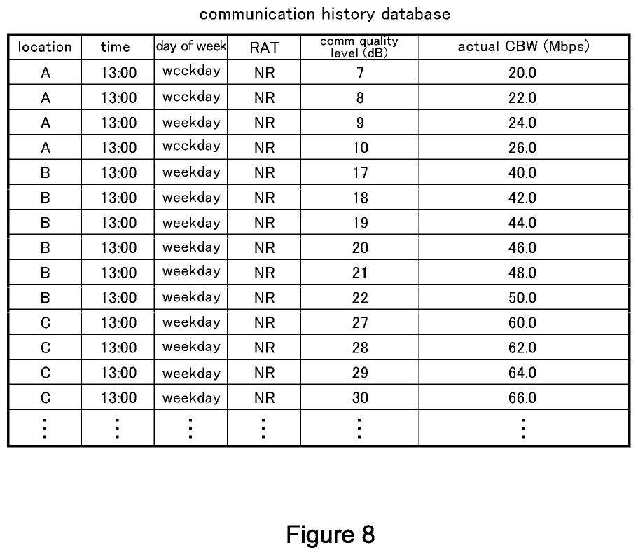

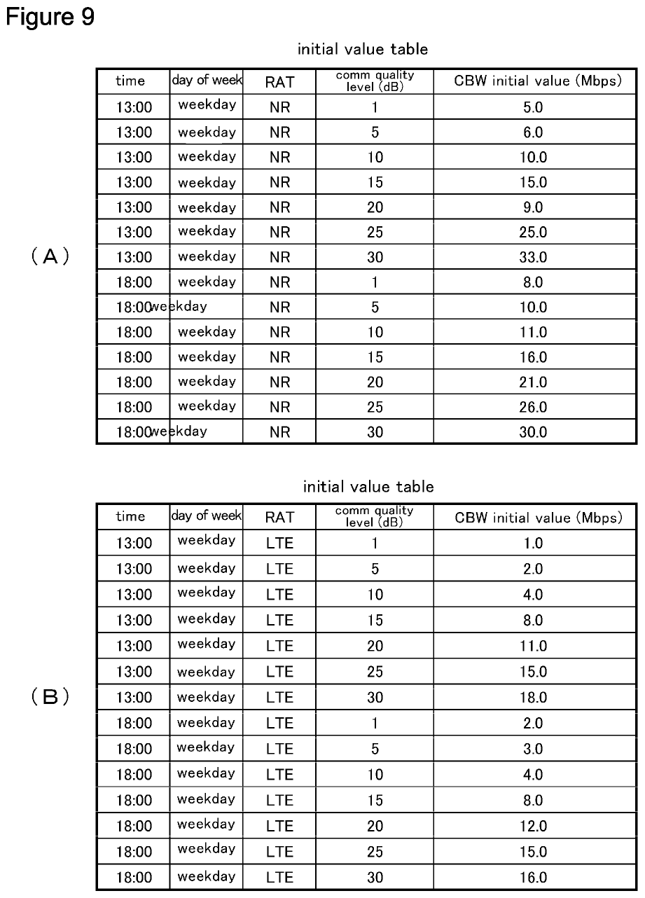

The storage 34 stores a communication history database (see FIG. 8) and an initial value table (see FIG. 9).

The controller 33 includes a wireless communication controller 41, a bandwidth controller 42, and an application controller 43 in the same manner as the first embodiment. In the second embodiment, the controller 33 further includes a historical information register 44, a historical information acquirer 45, and a terminal status acquirer 46.

When performing actual communication, the historical information register 44 registers information regarding the actual communication as historical information in the communication history database in the storage 34, the information regarding the actual communication including location information, information on date and time, connection destination information, communication quality level information, and communication bandwidth information (actual values of the communication bandwidth).

Upon receiving a request from the bandwidth controller 42, the historical information acquirer 45 searches the communication history database stored in the storage 34 and acquires historical information regarding the current location and on past communication status close to a current communication status (including items such as connection destination, wireless communication quality level, time of day, and day of the week) of the user terminal 1. When multiple pieces of such historical information are present, the latest piece of the historical information is retrieved.

In the historical information on past communication status to be retrieved, each item of communication status (such as time of day, day of the week, connection destination, and wireless communication quality level) is only required to be within a prescribes close range from a corresponding one in the current communication status, and it is not necessary for all the items to be very close to respective ones of the current communication status.

The terminal status acquirer 46 acquires information on a current location where the user terminal is present and information on the current date and time (day of the week or time of day) as terminal status information.

The bandwidth controller 42 controls the communication bandwidth based on the historical information regarding the current location acquired by the historical information acquirer 45. In the present embodiment, when historical information regarding the current location is present, the bandwidth controller 42 retrieves the past actual value of the communication bandwidth included in the acquired historical information as an initial value of the communication bandwidth, and starts control of the communication bandwidth by using the initial value. When historical information regarding the current location is not present, the bandwidth controller 42 refers to the initial value table (see FIG. 9) and acquires an initial value of the communication bandwidth, and using the acquired initial value, starts control of the communication bandwidth.

Next, the communication history database according to the second embodiment of the present invention will be described. FIG. 8 is an explanatory view showing an example of the communication history database.

In the present embodiment, when performing actual communication, the user terminal 1 registers in the communication history database historical information, the historical information including current location information and information on a current communication status (including items such as day of the week, time of day, connection destination, and wireless communication quality level) of the user terminal 1. When the user terminal 1 controls the communication bandwidth, the user terminal 1 acquires, from the communication history database, historical information on past communication status close to a current communication status of the user terminal 1, and then retrieves the actual value of the communication bandwidth included in the acquired historical information as an initial value of the communication bandwidth.

The communication history database includes registered information including location information, information on date and time (day of the week or time of day), connection destination information (RAT of each connection destination), communication quality level information (such as signal-to-noise ratio), and communication bandwidth information (actual values of the communication bandwidth).

In the present embodiment, the communication history database is configured to store, in addition to location information, information on date and time, connection destination information, communication quality level information, and communication bandwidth information. Also, the communication history database may further store information on the connection destination (counterpart communication device or server 2) and information on a moving speed so that the user terminal 1 can take these types of 1 information into consideration when retrieving historical information on past communication status close to a current communication status of the user terminal 1.

Next, the initial value table according to the second embodiment of the present invention will be described. FIG. 9 is an explanatory view showing examples of initial value tables.

In the present embodiment, the user terminal 1 acquires, based on the initial value table (initial setting information), an initial value of the communication bandwidth appropriate for a current communication status (including items such as day of the week, time of day, connection destination, and wireless communication quality level) of the user terminal 1. Such a communication bandwidth initial value acquisition operation based on the initial value table is performed when historical information on communication status close to a current communication status of the user terminal 1 is not present in the communication history database.

The initial value table includes registered information including information on current date and time (day of the week or time of day), connection destination information (RAT of each connection destination), communication quality level information (such as signal-to-noise ratio), and communication bandwidth information (initial values of the communication bandwidth). FIG. 9(A) shows an example of an initial value table associated with a small cell base station in which RAT of connection destinations is NR (New Radio). FIG. 9(B) shows an example of an initial value table associated with a macro cell base station in which RAT of a connection destination is LTE (Long Term Evolution).

In determining whether or not a communication status in a piece of historical information is close to a current communication status of the user terminal, each item of communication status is only required to be within a prescribes close range from a corresponding one in the current communication status, and it is not necessary for all the items to be very close to respective ones of the current communication status.

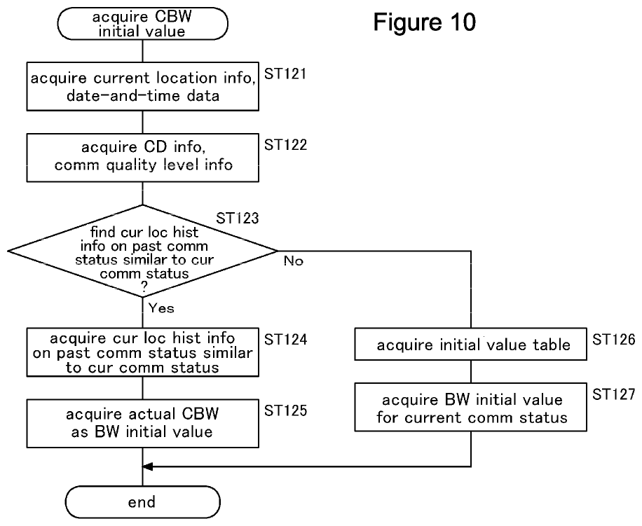

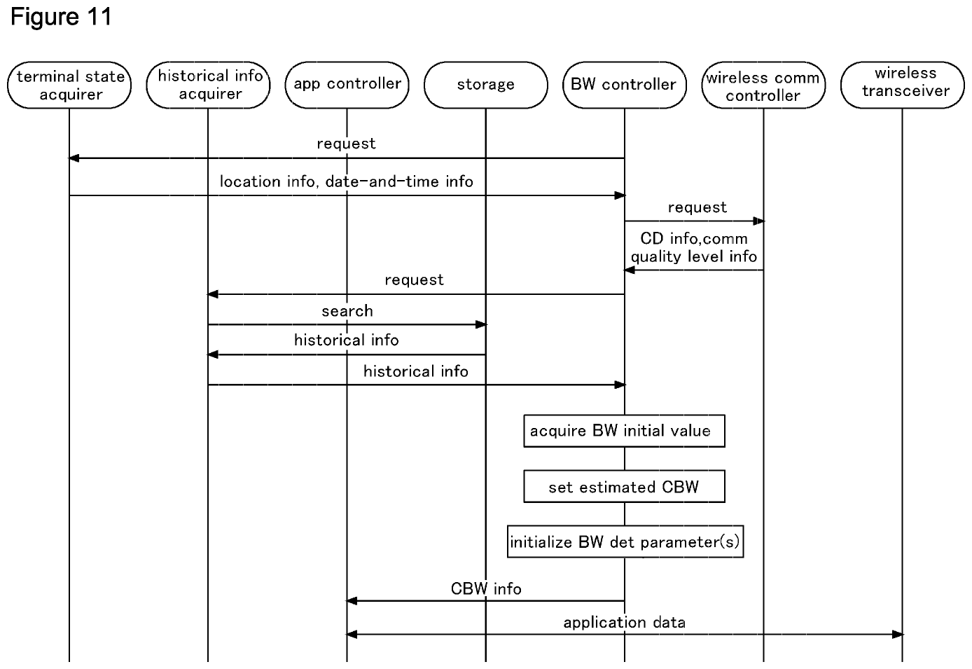

Next, an operation procedure of the user terminal 1 according to the second embodiment of the present invention will be described. FIG. 10 is a flowchart showing an operation procedure of a communication bandwidth initial value acquisition operation performed by the bandwidth controller 42 in the user terminal 1. FIG. 11 is a sequence diagram showing an operation procedure of the user terminal 1.

First, the bandwidth controller 42 acquires, from the terminal status acquirer 46, information on a current location of the user terminal and information on current date and time (day of the week or time of day) as terminal status information (ST121). The bandwidth controller 42 acquires information on a current connection destination and wireless communication quality level information from the wireless communication controller 41 (ST122).

Next, the bandwidth controller 42 requests the historical information acquirer 45 for historical information regarding the current location and on past communication status close to the current communication status (including items such as time of day, day of the week, connection destination, and wireless communication quality level) of the user terminal 1 (ST123). Upon receiving the request, the historical information acquirer 45 searches the communication history database stored in the storage 34 and acquires such historical information on past communication status.

When such requested historical information is found (Yes in ST123), the bandwidth controller 42 acquires the historical information from the historical information acquirer 45 (ST124), and then retrieves the actual value of the communication bandwidth included in the acquired historical information as an initial value of the communication bandwidth (ST125).

When such requested historical information is not present (No in ST123), the bandwidth controller 42 acquires the initial value table (see FIG. 9) from the storage 34 (ST126). Then, the bandwidth controller 42 retrieves, from the initial value table, an initial value of the communication bandwidth appropriate for the current communication status (including items such as time of day, day of the week, connection destination, and wireless communication quality level) of the user terminal 1 (ST127).

### Variation of Second Embodiment

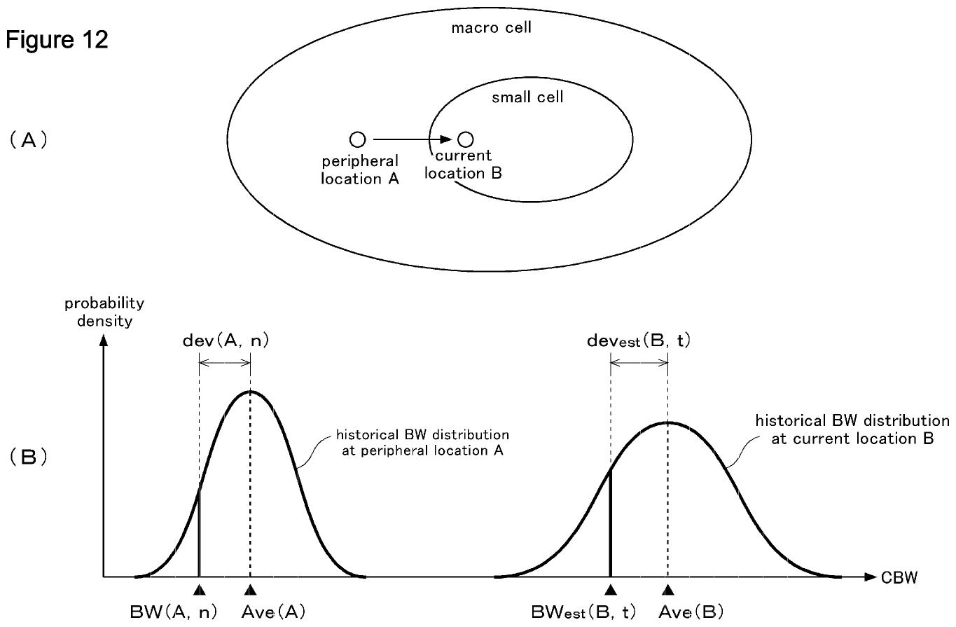

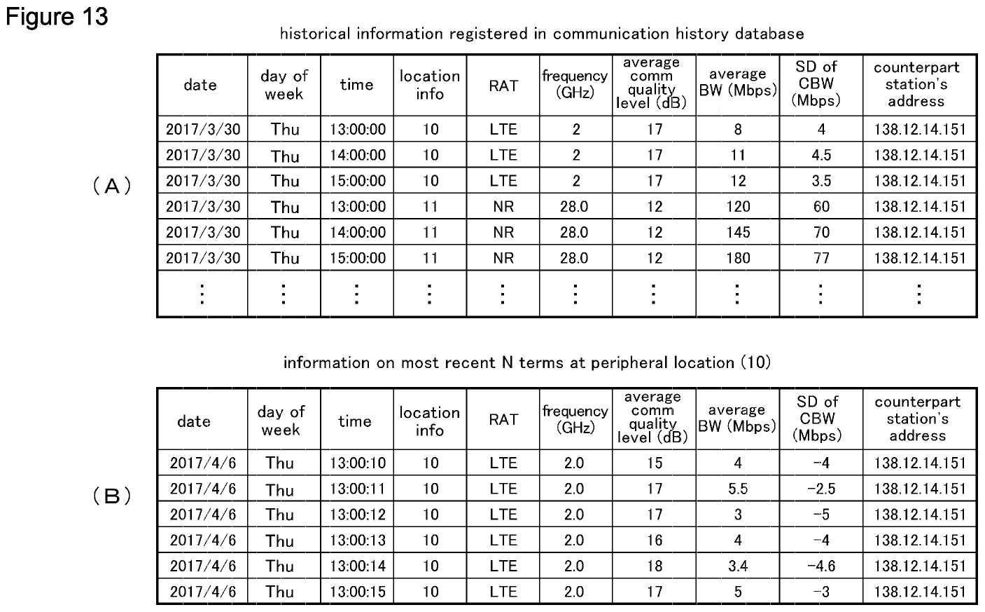

Next, a variation of the second embodiment of the present invention will be described. Except for what will be discussed here, this embodiment is the same as the above-described embodiments. FIG. 12 is an explanatory view showing an outline of control of bandwidth. FIG. 13 is an explanatory view showing an example of a communication history database.

In the second embodiment, the user terminal is configured to acquire an initial value of the communication bandwidth based on historical information regarding a current location and on past communication status. However, in this variation of the second embodiment, the user terminal acquires an initial value of the communication bandwidth based not only on historical information regarding a current location of the user terminal 1, but also on historical information regarding a peripheral location of the user terminal 1 (a nearby location from the current location of the user terminal 1).

As shown in FIG. 12(A), a communication area of a macro cell base station overlaps with that of a small cell base station. When the user terminal 1 which has been present in the communication area of the macro cell base station, moves and enters the communication area of the small cell base station, the user terminal 1 changes its connection destination from the macro cell base station to the small cell base station and also acquires an initial value based on both historical information regarding a current location B and historical information regarding a peripheral location A at which the user terimnal was located immediately before the present time (e.g. a location in which the user terminal 1 was located 10 seconds before).

As shown in FIG. 12 (B), a past communication bandwidth distribution (variation of actual values of the past communication bandwidth) in a specific day of the week and time zone is a normal distribution. It should be noted that a value of the communication bandwidth is relatively small at the peripheral location A, which falls within the communication area of the macro cell base station, while a value the communication bandwidth is relatively large at the current location B, which falls within the communication area of the small cell base station.

The shapes of communication bandwidth distributions at the locations A and B; that is, the variations of past actual values of the communication bandwidth are different from each other. However, it is deemed that the degrees of communication congestion at the locations A and B are correlated with (and similar to) each other. The degree of communication congestion can be represented by a deviation of past communication bandwidth distribution (difference from an average of actual values). A very high or very low degree of congestion of communication produces a large deviation of the communication bandwidth distribution.

In this view, in this variation of the second embodiment, the historical information acquirer 45 acquires historical information regarding the current location B and on past communication status close to a current communication status of the user terminal 1, and also acquires historical information regarding the peripheral location A.

Then, the bandwidth controller 42 obtains a communication bandwidth distribution at the peripheral location A from the historical information regarding the peripheral location A and also obtains a communication bandwidth distribution at the current location B from the historical information regarding the current location B. Next, the bandwidth controller 42 compares the communication bandwidth distribution at the peripheral location A with a value of the communication bandwidth (instantaneous value) at the peripheral location A at the time immediately before the present time to obtain a deviation, which represents the degree of communication congestion at the present time. Then, the bandwidth controller 42 applies the deviation to the communication bandwidth distribution at the current location B to thereby provide an estimated value of the communication bandwidth (instantaneous value) at the current location B at the present time, and set the estimated value of the communication bandwidth as an initial value of the communication bandwidth.

In particular, an estimated communication bandwidth West (B, t) at the current location B at the present time t of the user terminal 1 is calculated by adding an estimated deviation devₑₛₜ(B, t) representing the degree of communication congestion at the current location B at the present time t to an average of past actual values at the current location B Aveₑₛₜ(B) as the following formula (1).

BWₑₛₜ(B,t)=Ave(B)+devₑₛₜ(B,t) (1)

The average of past actual values at the current location B Aveₑₛₜ(B) is calculated from the historical information regarding the current location B.

The estimated deviation devₑₛₜ(B, t) at the current location B at the present time t is calculated by the formula (2) as indicated below.

In particular, the calculation involves the following steps: The first step is obtaining a deviation at each time n during the most recent period N at the peripheral locations A; that is, respective deviations dev (A, n) at times from time tN, (i.e. terms N before the present time t) to time t−1. The next step is dividing the total sum of the deviations by the period N to obtain an average value of the deviations during the most recent period N. The final step is multiplying the average value of the deviations by the ratio of the standard deviation σ_{B} of the distribution at the current location B to the standard deviation σ_{A} of the distribution at the peripheral location A, to thereby obtain an estimated value devₑₛₜ(B, t) of the deviation at the current location B at the present time t.

$${dev}_{est} ( B , t ) = \frac{{\sum }_{n = t - N}^{t - 1} dev ( A , n )}{N} \times \frac{{σ}_{B}}{{σ}_{A}} \qquad ( 2 )$$

Each of the deviations dev (A, n) at time n during the most recent period N at the peripheral location A is calculated by subtracting the actual value BW (A, n) of the communication bandwidth at time n from the average value Ave (A) of the past actual values of the communication bandwidth at the peripheral location A as shown in the following formula equation. The average value Ave (A) of the past actual values of the communication bandwidth at the peripheral location A is calculated from the historical information regarding the peripheral location A.

dev(A, n)=Ave(A)−BW(A, n) (3)

The radius of the communication area of a macro cell base station (LTE) is about 500 m, and when one unit distance of movement for collecting historical information is within a range of 10 m to 20 m, the most recent period N may be within a range of 10 s to 20 s.

An example shown in FIG. 13(A) is historical information registered in the communication history database. In this example, the information registered in the communication history database includes items consisting of date, day of week, time, location information, RAT, frequency, average value of wireless communication quality levels, average value of the communication bandwidth, standard deviation of the communication bandwidth, and counterpart station's address.

An example shown in FIG. 13(B) is information collected during the most recent period N at the peripheral location (10). The information in FIG. 13(B) includes an item of deviation dev (10, n) at each time as indicated in the following formula equation 4; that is, a deviation from an average value of the communication bandwidth values in the historical information registered in the communication history database.

In the case of the example shown in FIG. 13(B), an estimated deviation devₑₛₜ(11, 13:00:16) of the user terminal 1 at the current location (11) at the present time (13:00:16) is calculated by using the formula equation (2) as shown in the following formula (4).

$${dev}_{est} ( 11 , 13 \text{:} 00 \text{:} 16 ) = \frac{{\sum }_{n = 10}^{15} dev ( 10 , n )}{6} \times \frac{60}{4} = - 3.85 \times 15 = - 57.75 \qquad ( 4 )$$

An estimated communication bandwidth BWₑₛₜ(11, 13:00:16) of the user terminal 1 at the current location (11) at the present time (13:00:16) is calculated by using the formula equation (1) as shown in the following formula (5).

BWₑₛₜ(11,13:00:16)=120−57.75=62.25 (5)

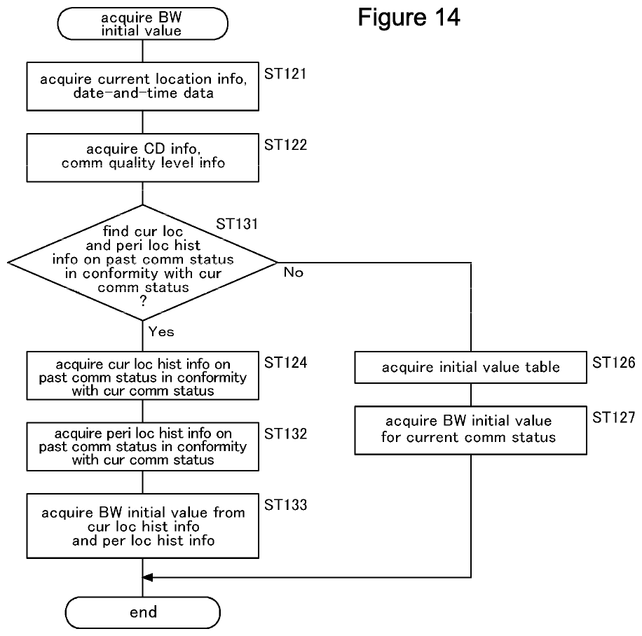

Next, an operation procedure of the user terminal according to the variation of the second embodiment of the present invention will be described. FIG. 14 is a flowchart showing an operation procedure of a communication bandwidth initial value acquisition operation performed by the bandwidth controller 42 in the user terminal.

First, the bandwidth controller 42 acquires information regarding a current location at which the user terminal is located and information on current date and time (day of the week or time of day) as terminal status information from the terminal status acquirer 46 (ST121). The bandwidth controller 42 acquires information on a current connection destination and wireless communication quality level information from the wireless communication controller 41 (ST122).

Next, the bandwidth controller 42 requests the historical information acquirer 45 for historical information regarding the current location and that regarding the peripheral location and both on past communication status close to the current communication status (including items such as time of day, day of the week, connection destination, and wireless communication quality level) of the user terminal 1 (ST131). Upon receiving the request, the historical information acquirer 45 searches the communication history database stored in the storage 34 and acquires requested historical information on past communication status.

When such requested historical information is found (Yes in ST131), the bandwidth controller 42 acquires the historical information regarding the current location and on past communication status close to the current communication status from the historical information acquirer 45 (ST124). Also, the bandwidth controller 42 acquires the historical information regarding the peripheral location and on past communication status close to the current communication status from the historical information acquirer 45 (ST132). Then, the bandwidth controller 42 acquires an initial value of the communication bandwidth based on both the historical information regarding the current location and that regarding the peripheral location (ST133).

When such requested historical information is not present (No in ST131), the bandwidth controller 42 acquires the initial value table (see FIG. 9) from the storage 34 (ST126). Then, the bandwidth controller 42 retrieves, from the initial value table, an initial value of the communication bandwidth appropriate for the current communication status (such as time of day, day of the week, connection destination, and wireless communication quality level) of the user terminal 1 (ST127).

### Third Embodiment

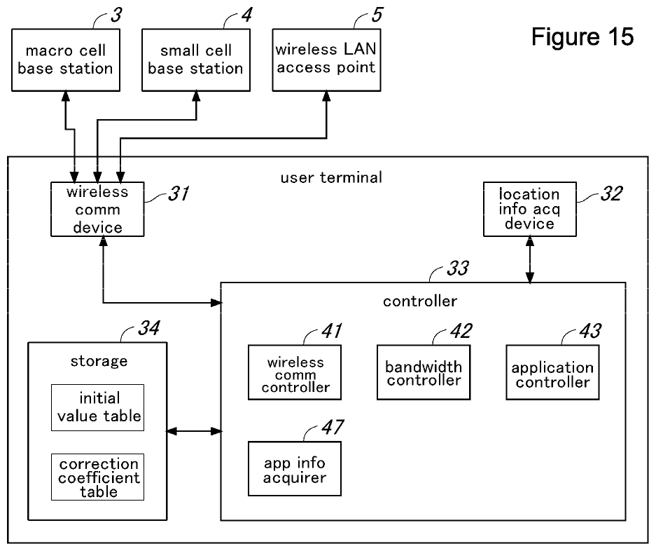

Next, a third embodiment of the present invention will be described. Except for what will be discussed here, this embodiment is the same as the above-described embodiments. FIG. 15 is a block diagram showing a general configuration of a user terminal 1 according to a third embodiment of the present invention.

Required communication performance such as communication stability varies depending on a type of application presently performing communication. In this view, in the present embodiment, a controller is configured to control a communication bandwidth to be given to the application controller 43 base on the type of application presently performing communication.

The user terminal 1 includes a wireless communication device 31, a location information acquisition device 32, a controller 33, and a storage 34 in the same manner as the first embodiment. The wireless communication device 31 has the same configuration as that of the first embodiment.

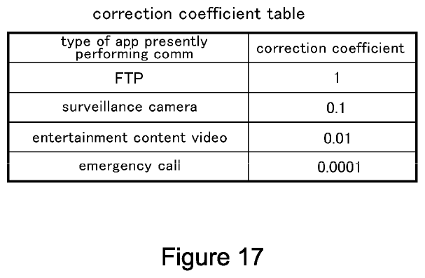

The storage 34 stores, in addition to the initial value table (see FIG. 4), a correction coefficient table (see FIG. 17).

The controller 33 includes a wireless communication controller 41, a bandwidth controller 42, and an application controller 43 in the same manner as the first embodiment. In the third embodiment, the controller 33 further includes an application information acquirer 47.

The application information acquirer 47 monitors communication performed by the application controller and acquires application information on a type of application presently performing communication.

The bandwidth controller 42 controls a communication bandwidth based on the application information acquired by the application information acquirer 47. In the present embodiment, when the connection destination is changed, the bandwidth controller 42 acquires an initial value of the communication bandwidth based on the type of application presently performing communication, and using the acquired initial value, starts control of the communication bandwidth.

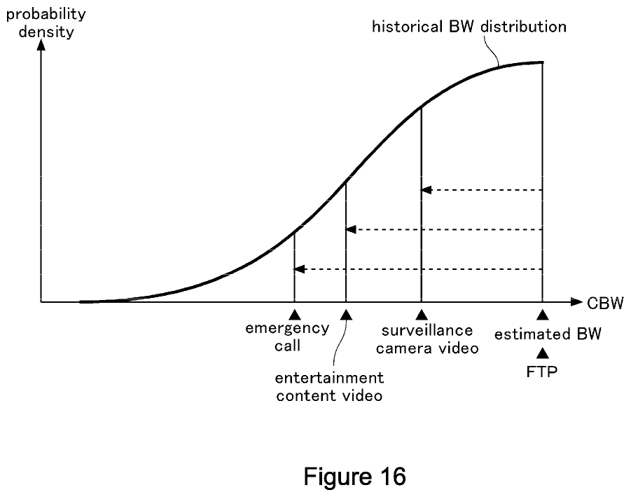

Next, control of the bandwidth according to the third embodiment of the present invention will be described. FIG. 16 is an explanatory view showing how the bandwidth is controlled.

In the present embodiment, the communication bandwidth is controlled based on a type of application presently performing communication.

For example, in the case of an application for notifying a user of an emergency call transmitted from an emergency call system, the communication bandwidth is controlled in a safer manner; that is, to be reduced so that it is ensured that the emergency call can be received.

In the case of an application for viewing entertainment content video data distributed from the server 2 in a streaming video form or any other form, user satisfaction is significantly reduced by streaming video interruptions by pauses due to available bandwidth estimation errors. Thus, in order to reduce streaming video interruptions, the communication bandwidth is controlled in a safer manner, that is, to be reduced so as to minimize its exceedance over an actual available bandwidth.

In the case of an application for viewing video data transmitted from surveillance cameras, high resolution video is required for identification of the face of a person located far from a camera and video interruptions do not so matter as the cases of entertainment contents. Thus, the communication bandwidth is controlled to be closer to an actual available bandwidth.

In the case of an application for transferring data using FTP (File Transfer Protocol), since interruptions of communication do not matter so much, the communication bandwidth is controlled to be as large as possible, thereby enabling efficient use of an available bandwidth.

Next, the correction coefficient table according to the third embodiment of the present invention will be described. FIG. 17 is an explanatory view showing an example of a correction coefficient table.

In the present embodiment, an initial value of the communication bandwidth is acquired based on the type of application. In particular, in the present embodiment, the bandwidth controller acquires an initial value of the communication bandwidth appropriate for the connection destination from the initial value table (see FIG. 4), and then acquires an correction coefficient appropriate for the type of application to correct the initial value of the communication bandwidth by multiplying the initial value of the communication bandwidth by the correction coefficient, thereby obtaining a corrected initial value. The bandwidth controller uses a correction coefficient table (correction coefficient setting information) when acquiring thee correction coefficient appropriate for each type of application.

This correction coefficient table includes correction coefficients, each correction coefficient being appropriate for a corresponding type of application. In the example of FIG. 17, the table includes respective correction coefficients appropriate for several types of applications, which include, but not limited to, applications for FTP (File Transfer Protocol), applications for viewing video data transmitted from surveillance cameras, applications for viewing entertainment content video data, and applications for notifying a user of an emergency call.

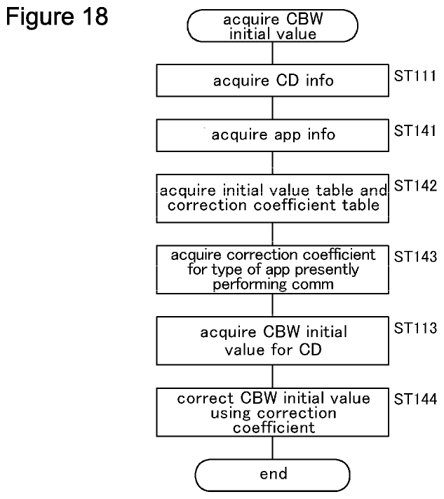

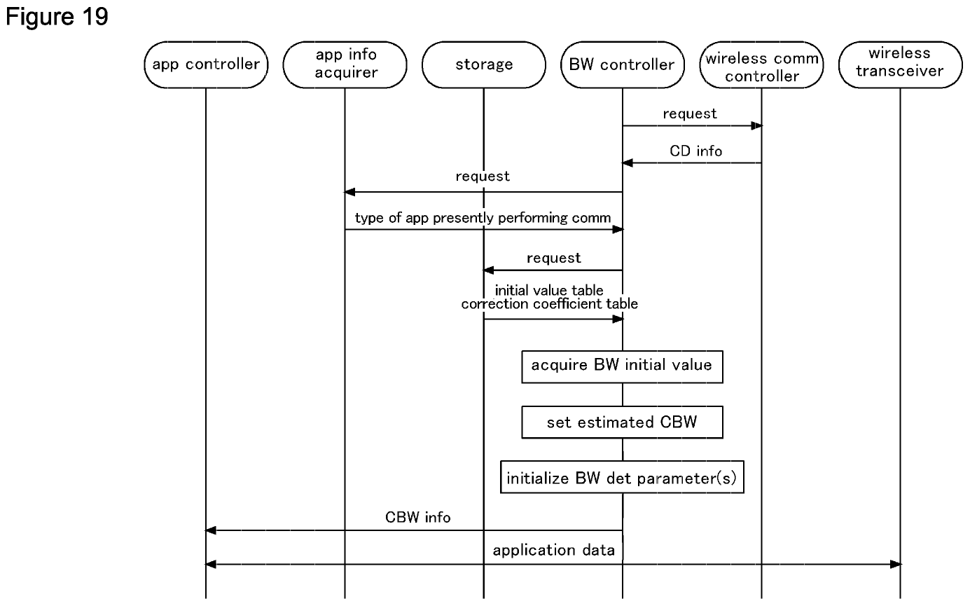

Next, an operation procedure of the user terminal 1 according to the third embodiment of the present invention will be described. FIG. 18 is a flowchart showing an operation procedure of a communication bandwidth initial value acquisition operation performed by a bandwidth controller 42 in the user terminal 1. FIG. 19 is a sequence diagram showing an operation procedure of the user terminal 1.

First, the bandwidth controller 42 acquires connection destination information from the wireless communication controller 41 (ST111). Also, the bandwidth controller 42 acquires application information on a type of application presently performing communication from the application information acquirer 47 (ST141). Then, the bandwidth controller 42 acquires the initial value table and the correction coefficient table from the storage 34 (ST142).

Then, the bandwidth controller 42 acquires a correction coefficient appropriated for the type of application presently performing communication (ST143). Also, the bandwidth controller 42 acquires an initial value of the communication bandwidth appropriate for the connection destination from the initial value table (ST113). Then, the bandwidth controller 42 corrects the initial value of the communication bandwidth by using the correction coefficient (ST144). Specifically, the bandwidth controller 42 corrects the initial value of the communication bandwidth by multiplying the initial value of the communication bandwidth by the correction coefficient to acquire a corrected initial value of the communication bandwidth.

### Fourth Embodiment

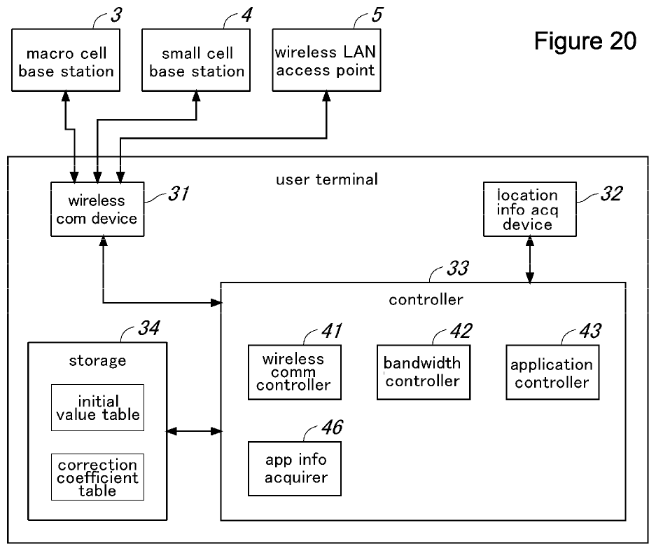

Next, a fourth embodiment of the present invention will be described. Except for what will be discussed here, this embodiment is the same as the above-described embodiments. FIG. 20 is a block diagram showing a general configuration of a user terminal 1 according to the fourth embodiment of the present invention.

When the user terminal 1 does not move, a communication bandwidth is stable, and thus an available bandwidth estimation error (an error from the estimated value of the communication bandwidth) is small. When the user terminal 1 is moving, a communication bandwidth is unstable, and thus such an available bandwidth estimation error becomes large and the error varies with the moving speed of the user terminal. In this view, in the present embodiment, a communication bandwidth is controlled based on a moving speed of the user terminal 1.

The user terminal 1 includes a wireless communication device 31, a location information acquisition device 32, a controller 33, and a storage 34 in the same manner as the first embodiment. The wireless communication device 31 has the same configuration as that of the first embodiment.

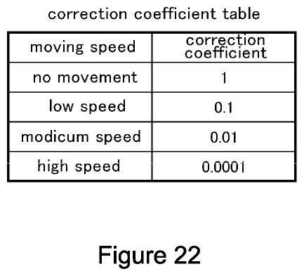

The storage 34 stores, in addition to the initial value table (see FIG. 4), a correction coefficient table (see FIG. 22).

The controller 33 includes a wireless communication controller 41, a bandwidth controller 42, and an application controller 43 in the same manner as the first embodiment. In the second embodiment, the controller 33 further includes a terminal status acquirer 46.

The terminal status acquirer 46 acquires a moving speed of the user terminal calculated form location information on each location of the user terminal acquired as terminal status information by the location information acquisition device 32.

The bandwidth controller 42 controls a communication bandwidth based on the terminal status information acquired by the terminal status acquirer 46. In the present embodiment, when the connection destination is changed, the bandwidth controller 42 acquires an initial value of the communication bandwidth based on the speed of the user terminal, and using the acquired initial value, starts control of the communication bandwidth.

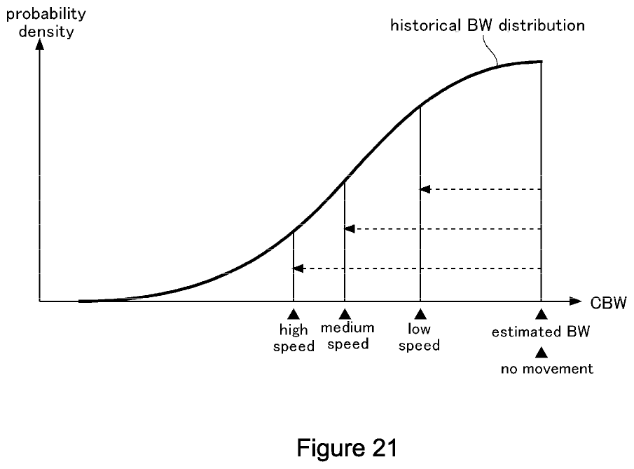

Next, control of the bandwidth according to the first embodiment of the present invention will be described. FIG. 21 is an explanatory view showing how the bandwidth is controlled.

In the present embodiment, the communication bandwidth is controlled based on a moving speed of the user terminal. Specifically, when the user terminal 1 does not move, a communication bandwidth is stable, and thus an available bandwidth estimation error (an error from the estimated value of the communication bandwidth) is small. Thus, the communication bandwidth is controlled to be as large as possible, thereby enabling efficient use of an available bandwidth.

When the user terminal 1 is moving, a communication bandwidth is unstable, and thus the available bandwidth estimation error becomes large. Thus, the communication bandwidth is controlled in a safer manner; that is, to be reduced. More specifically, as the moving speed increases such that the user terminal moves at a low speed, then at a medium speed, and then at a high speed, the communication bandwidth becomes significantly unstable. Therefore, the communication bandwidth is controlled such that the higher the moving speed becomes, the smaller the communication bandwidth is.

Next, the correction coefficient table according to the fourth embodiment of the present invention will be described. FIG. 22 is an explanatory view showing an example of a correction coefficient table.

In the present embodiment, an initial value of the communication bandwidth is acquired based on the moving speed of the user terminal. In particular, in the present embodiment, the bandwidth controller acquires an initial value of the communication bandwidth appropriate for the connection destination from the initial value table (see FIG. 4), and then acquires an correction coefficient appropriate for the moving speed of the user terminal to correct the initial value of the communication bandwidth by multiplying the initial value of the communication bandwidth by the correction coefficient, thereby obtaining a corrected initial value. The bandwidth controller uses a correction coefficient table (correction coefficient setting information) when acquiring the correction coefficient for the moving speed of the user terminal.

This correction coefficient table includes correction coefficients, each correction coefficient being appropriate for a corresponding moving speed of a user terminal. In the present embodiment, the moving speed is compared with multiple threshold values, and classified into speed levels of speed; that is, no movement, low speed, medium speed, and high speed. The correction coefficient table includes a corresponding correction coefficient for each speed level.

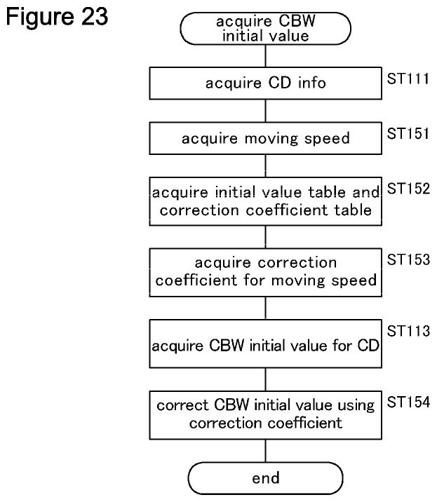

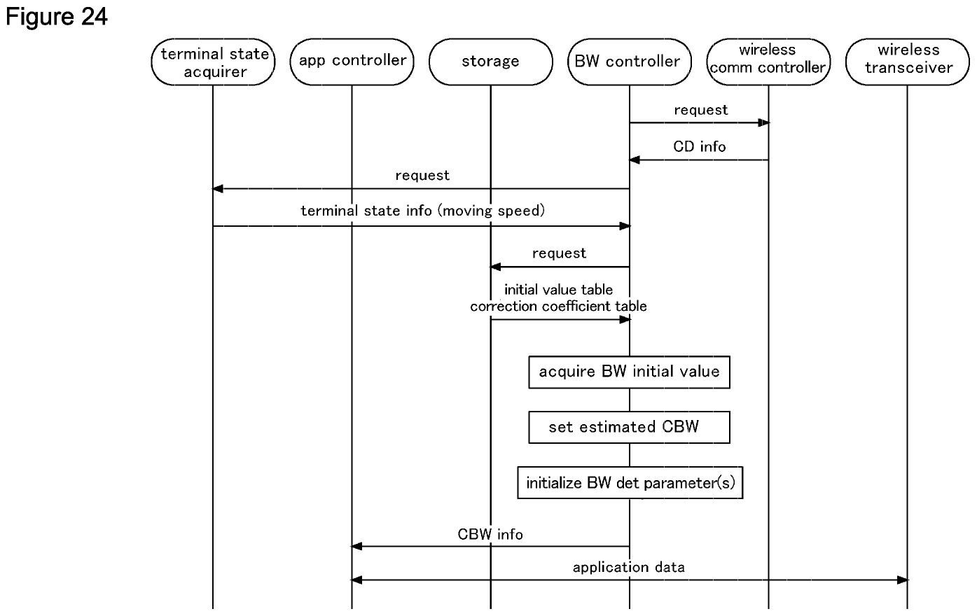

Next, an operation procedure of the user terminal 1 according to the fourth embodiment of the present invention will be described. FIG. 23 is a flowchart showing an operation procedure of a communication bandwidth initial value acquisition operation performed by the bandwidth controller 42 in the user terminal 1. FIG. 24 is a sequence diagram showing an operation procedure of the user terminal 1.

First, the bandwidth controller 42 acquires connection destination information from the wireless communication controller 41 (ST111). Also, the bandwidth controller 42 acquires a moving speed from the terminal status acquirer 46 (ST151). Then, the bandwidth controller 42 acquires the initial value table and the correction coefficient table from the storage 34 (ST152).

Then, the bandwidth controller 42 acquires a correction coefficient appropriated for the moving speed (ST133). Also, the bandwidth controller 42 acquires an initial value of the communication bandwidth appropriate for the connection destination from the initial value table (ST113). Then, the bandwidth controller 42 corrects the initial value of the communication bandwidth by using the correction coefficient (ST154). Specifically, the bandwidth controller 42 corrects the initial value of the communication bandwidth by multiplying the initial value of the communication bandwidth by the correction coefficient to acquire a corrected initial value of the communication bandwidth.

In the third embodiment, the communication bandwidth is controlled based on a type of application presently performing communication, while, in the fourth embodiment, the communication bandwidth is controlled based on a moving speed of the user terminal. However, the communication bandwidth may be controlled using the combination of these two control methods.

In this case, the communication bandwidth is preferably controlled in a safer manner; that is, controlled by using a smaller one of two communication bandwidths determined by the two control methods. For example, when the type of application presently performing communication is FTP and the user terminal 1 is moving at high speed, the initial value determined for the moving speed is adopted because the initial value for the moving speed is smaller than that for the type of application. For another example, when the user terminal 1 does not move and the type of application presently performing communication is an emergency call application, the initial value for the type of application is adopted because the initial value for the type of application is smaller than that for the moving speed.

### Fourth Embodiment

Next, a fourth embodiment of the present invention will be described. Except for what will be discussed here, this embodiment is the same as the above-described embodiments.

In the first to fourth embodiments, when a change in the connection destination occurs, an initial value of the communication bandwidth is acquired, and the acquired initial value is used to start control of the communication bandwidth. However, in the present embodiment, when a rapid change in the communication quality level occurs due to an obstacle or other factors, an initial value of the communication bandwidth is acquired, and the acquired initial value is used to start control of the communication bandwidth.

The user terminal 1 has the same configuration as that of the first embodiment (see FIG. 3).

The initial value table (initial value setting information) stored in the storage 34 includes initial values of the communication bandwidth, each value being appropriate for a corresponding wireless communication quality level (such as signal-to-noise ratio).

The bandwidth controller 42 controls a communication bandwidth based on information on a wireless communication quality level acquired from the wireless communication controller 41. In the present embodiment, when a rapid change in the wireless communication quality occurs due to an obstacle or other factors, the bandwidth controller 42, referring to the initial value table, acquires an initial value of the communication bandwidth appropriate for the changed wireless communication quality level, and using the acquired initial value, starts control of the communication bandwidth.

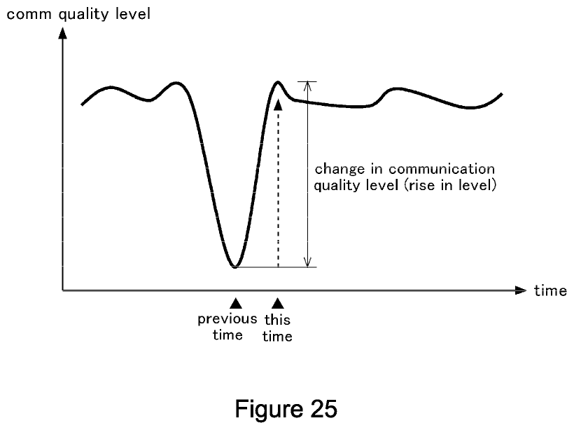

Next, control of the bandwidth according to the fifth embodiment of the present invention will be described. FIG. 25 is an explanatory view showing changes in the wireless communication quality level.

In the present embodiment, the bandwidth controller compares a change in the communication quality level (rise in level); that is, a difference between a current wireless communication quality level and a previous wireless communication quality level with a prescribed threshold value, and through the comparison, the bandwidth controller can detect a rapid change in the wireless communication quality level caused due to an obstacle or other factors. The bandwidth controller performs this comparison operation on a regular basis at a predetermined timing, in which, when a change in the wireless communication quality level exceeds the prescribed threshold value, the bandwidth controller acquire an initial value of the communication bandwidth, and using the acquired initial value, starts controlling the communication bandwidth.

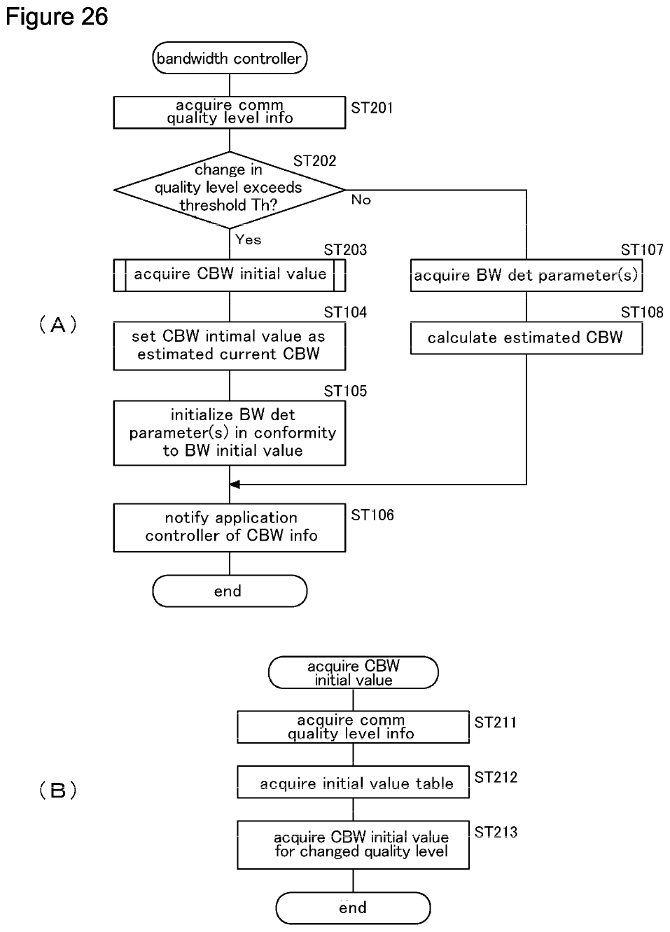

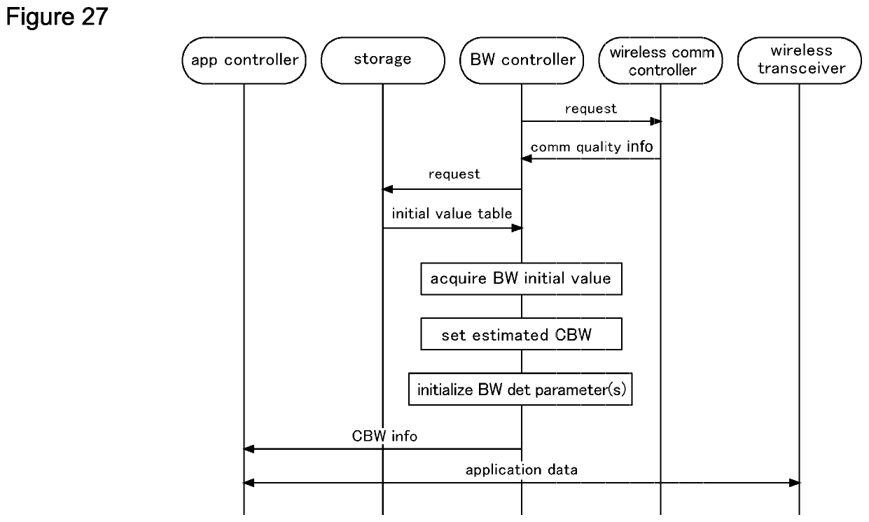

Next, an operation procedure of the user terminal 1 according to the fifth embodiment of the present invention will be described. FIG. 26 is a flowchart showing an operation procedure of the bandwidth controller 42 in the user terminal 1. FIG. 27 is a sequence diagram showing an operation procedure of the user terminal 1.

First, as shown in FIG. 26(A), the bandwidth controller 42 acquires information on a wireless communication quality level from the wireless communication controller 41 (ST201). Then, the bandwidth controller 42 determines whether or not a change in the wireless communication quality level exceeds a prescribed threshold value Th (ST202).

When a change in the wireless communication quality level exceeds the prescribed threshold value Th (Yes in ST202), the bandwidth controller 42 acquires an initial value of the communication bandwidth (ST203). The subsequent steps are the same as in the first embodiment. Similarly, when a change in the wireless communication quality level exceeds the prescribed threshold value Th (Yes in ST202), the subsequent steps are the same as those of the first embodiment.

In the step of acquiring an initial value of the communication bandwidth (ST203), As shown in FIG. 26(B), the bandwidth controller 42 acquires information on a wireless communication quality level from the wireless communication controller 41 (ST211). Also, the bandwidth controller 42 acquires the initial value table from the storage 34 (ST112). Then, the bandwidth controller 42 acquires an initial value of the communication bandwidth appropriate for the changed wireless communication quality level from the initial value table (ST213).

The above-described control of the communication bandwidth based on the wireless communication quality level may be performed when a change in the connection destination does not occur. In this case, when the bandwidth controller 42 acquires connection destination information from the wireless communication controller 41 and detects no change in the connection destination, the bandwidth controller 42 performs the control of the communication bandwidth according to the present embodiment, while, when the bandwidth controller 42 detects a change in the connection destination, the bandwidth controller 42 performs control of the communication bandwidth according to any of the first to fourth embodiments.

While specific embodiments of the present invention are described herein for illustrative purposes, the present invention is not limited thereto. It will be understood that various changes, substitutions, additions, and omissions may be made for elements of the embodiments without departing from the scope of the invention. In addition, elements and features of the different embodiments may be combined with each other as appropriate to yield an embodiment which is within the scope of the present invention.

### INDUSTRIAL APPLICABILITY

A communication device, a communication system and a band control method according to the present invention achieve an effect of enabling proper control of the communication bandwidth without increasing load of a network, and are useful as a communication device for communicating application data via a base station used as a connection destination, a communication system in which a communication device communicates application data via a base station used as a connection destination, and a band control method for controlling a communication bandwidth used by a communication device to communicate application data via a base station used as a connection destination.

### GLOSSARY

1 user terminal (communication device)
2 server
3 macro cell base station (base station device)
4 small cell base station (base station device)
5 access point (base station device)
6 communication control device
31 wireless communication device
32 location information acquisition device
33 controller
34 storage

1. A communication device for communicating application data via a base station used as a connection destination, the communication device comprising:
a wireless communication device configured to wirelessly communicate with the base station used as the connection destination;
a storage configured to store initial setting information concerning an initial value of a communication bandwidth appropriate for the connection destination; and
a controller configured to control the communication bandwidth used for transferring the application data by using a congestion control algorithm, and configured such that, when the connection destination is changed, the controller acquires the initial value of the communication bandwidth appropriate for the connection destination based on the initial setting information, and starts controlling the communication bandwidth by using the initial value.

2. The communication device according to claim 1, wherein the storage is configured to accumulate historical information on past communication status, and
wherein, when the storage stores historical information on past communication status close to a current communication status of the communication device, the controller acquires, based on the historical information, the initial value of the communication bandwidth, and when the storage does not store historical information on past communication status close to the current communication status of the communication device, the controller acquires, based the initial setting information, the initial value of the communication bandwidth.

3. The communication device according to claim 2, wherein the controller acquires the initial value of the communication bandwidth based on the historical information regarding a current location of the communication device.

4. The communication device according to claim 2, wherein the controller acquires the initial value of the communication bandwidth based on the historical information regarding both a current location and a peripheral location, the peripheral location being is an immediately preceding location of the communication device before the communication device coming to the current location.

5. The communication device according to claim 4, wherein the controller
acquires, from the historical information regarding the current location, a past communication bandwidth distribution at the current location,
acquires, from the historical information regarding the peripheral location, a past communication bandwidth distribution at the peripheral locations,
determining a deviation of an immediately preceding communication bandwidth at the peripheral location from the past communication bandwidth distribution at the peripheral locations, and applying the determined deviation to the past communication bandwidth distribution at the current location to thereby acquire a current communication bandwidth at the current location, and then set the acquired current communication bandwidth as an initial value of the communication bandwidth.

6. The communication device according to claim 1, wherein the controller acquires the initial value of the communication bandwidth based on a type of application presently performing communication.

7. The communication device according to claim 6, wherein the storage stores correction coefficient setting information on a correction coefficient appropriate for the type of application presently performing communication; and
wherein the controller, which acquires the initial value of the communication bandwidth appropriate for the connection destination based on the initial setting information, also acquires the correction coefficient appropriate for the type of application based on the correction coefficient setting information, and corrects the initial value of the communication bandwidth by multiplying the initial value of the communication bandwidth by the correction coefficient.

8. The communication device according to claim 1, wherein the controller acquires the initial value of the communication bandwidth based on a moving speed of the communication device.

9. The communication device according to claim 8, wherein the storage stores correction coefficient setting information on a correction coefficient appropriate for the moving speed of the communication device; and
wherein the controller, which acquires the initial value of the communication bandwidth appropriate for the connection destination based on the initial setting information, also acquires the correction coefficient appropriate for the moving speed of the communication device based on the correction coefficient setting information, and corrects the initial value of the communication bandwidth by multiplying the initial value of the communication bandwidth by the correction coefficient.

10. A communication device for communicating application data via a base station used as a connection destination, the communication device comprising:
a wireless communication device configured to wirelessly communicate with the base station used as the connection destination;
a storage configured to store initial setting information concerning an initial value of the communication bandwidth appropriate for a wireless communication quality level; and
a controller configured to control a communication bandwidth used for transferring the application data by using a congestion control algorithm, and configured such that, when a change in the wireless communication quality level exceeds a prescribed threshold value, the controller acquires the initial value of the communication bandwidth appropriate for the changed wireless communication quality level based on the initial setting information, and starts control of the communication bandwidth by using the initial value.

11. A communication system in which a communication device communicates application data via a base station used as a connection destination, wherein the communication device comprises:
a wireless communication device configured to wirelessly communicate with the base station used as the connection destination;
a storage configured to store initial setting information concerning an initial value of the communication bandwidth appropriate for the connection destination; and
a controller configured to control a communication bandwidth used for transferring the application data by using a congestion control algorithm, and configured such that, when the connection destination is changed, the controller acquires the initial value of the communication bandwidth appropriate for the connection destination based on the initial setting information, and starts control of the communication bandwidth by using the initial value.

12. (canceled)

13. A band control method for controlling a communication bandwidth used by a communication device to communicate application data via a base station used as a connection destination, the method comprising:
the communication device controlling a communication bandwidth used for transferring the application data by using a congestion control algorithm, and
when the connection destination is changed, the communication device acquiring an initial value of the communication bandwidth appropriate for the connection destination based on initial setting information stored in the communication device, and starting control of the communication bandwidth by using the initial value.
